(19) United States
(12) Patent Application Publication
(10) Pub. No.: US 2009/0035092 A1
(43) Pub. Date: Feb. 5, 2009

(54) Screw for Use in Thermally Loaded Surroundings

(76) Inventor: Thomas Thiemann, Recklinghausen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/223,489

(22) PCT Filed: Jan. 15, 2007
(86) PCT No.: PCT/EP2007/050349

§ 371 Date: Jul. 31, 2008

(30) Foreign Application Priority Data
Feb. 2, 2006 (EP) 06002174.8

(51) Int. Cl. F16B 35/04

(52) U.S. Cl. 411/424

(57) ABSTRACT

The invention relates to a screw having a lower and an upper end for connecting a first component to a second component. A hollow space which is arranged in the longitudinal direction is formed in the screw. A medium is filled into this hollow space. The hollow space is configured as a heat exchanger tube, as a result of which satisfactory cooling is achieved for the screw.

### CROSS REFERENCE TO RELATED APPLICATIONS

This application is the US National Stage of International Application No. PCT/EP2007/050349 filed Jan. 15, 2007 and claims the benefit thereof. The International Application claims the benefits of European application No. 06002174.8 filed Feb. 2, 2006, both of the applications are incorporated by reference herein in their entirety.

### FIELD OF THE INVENTION

The invention relates to a screw with a lower and an upper end for connecting a first component to a second component, wherein the screw comprises a cavity along its longitudinal direction. Furthermore, the invention relates to a screw with a lower and an upper end for connecting a first component and a second component, wherein the screw comprises a bore.

### BACKGROUND OF THE INVENTION

Screwed connections are used in many areas of mechanical engineering. In particular, screwed connections play an especially important role during the construction of turbomachines, since the pressures and forces which occur are high, at comparatively high temperatures.

Water turbines, steam and gas turbines, windmills, centrifugal pumps and centrifugal compressors, and also propellers, are brought together under the collective name of turbomachines. Common to all these machines is that they serve the purpose of extracting energy from a fluid in order to drive another machine with it or, vice versa, feeding energy to a fluid in order to increase its pressure.

In the aforementioned fields, screwed connections are used which are exposed to very high forces. In many cases, the screws must also withstand high thermal loads in addition to the high forces. Screwed connections are exposed in part to very high temperatures particularly in steam or gas turbine construction.

The steam valves which are used in steam turbine construction are frequently constructed with screwed connections which are also exposed to high thermal loads. There are screws which are known for screwed connections which are produced from ferritic screw materials. Since the material properties, such as the strength of ferritic materials, change as temperature increases, these materials are used only up to an upper limiting temperature.

Efforts are undertaken to widen the range of application of proven screwed connections by means of intensive local cooling. It is known from the prior art to provide screws with bores, wherein a cooling medium flows through the bore and the screw is cooled as a result. In the case of this cooling principle, the cooling medium has to be guided to the screw by means of devices via circulating systems. The construction of this cooling circuit is costly since the cooling medium has to be guided through devices such as pumps, filters, pipes, or the like.

A further possibility of modifying screws in such a way that they can be used for high thermal loads lies in using materials which are suitable for high temperatures. For example materials from the range of nickel-based alloys were a possibility in this case. However, the selection and the use of new materials is time-consuming and cost-intensive. These materials frequently also have unfavorable properties, such as “negative creep”.

It is known according to the prior art to form screwed connections with corresponding special alloys. These screwed connections can consequently be used at high temperatures. However, the costs of these alloys are comparatively high. Furthermore, the production of the screws is costly, which leads to a low availability.

If screws consisting of nickel-based alloys are used, as a rule expansion sleeves are necessary on account of the unfavorable thermal expansion behavior. The design of the expansion sleeves requires the accurate knowledge of the local temperature conditions of the screw.

### SUMMARY OF THE INVENTION

It is the object of the invention to disclose a screw which can be used at high thermal loads.

The object is achieved by means of a screw with a lower and an upper end for connecting a first component to a second component, wherein the screw comprises a cavity along its longitudinal direction. The cavity can have a bottom at the lower end for forming a beaker-like cavity, wherein the cavity is formed for filling with a medium. The cavity can also be continuous so that a special pipe which is filled with a medium can be inserted.

The invention utilizes the effect of the heat pipe principle. The heat pipe principle is thermodynamically based on the evaporation of a medium at the hot end and the condensation of the medium at a cold end inside a cavity which is formed with a longish shape. Relatively large quantities of heat are already conducted in the case of small temperature differences between the ends of the self-contained cavity. The principle of the heat pipe is as follows: at the hotter pipe end, the liquid evaporates and absorbs evaporation heat in the process. At the cooler end, the liquid condenses and gives off the evaporation heat. The principle can also be applied in the case of a horizontal arrangement. In this case, the wall is to be constructed with capillaries. As a result of the capillary action of the inner wall the condensate flows back again to the hotter pipe end. On account of the high evaporation enthalpy, heat pipes enable a heat transfer which is better by orders of magnitude than for example steel.

A screw in a thermally loaded environment customarily has a temperature gradient. For example, the lower end can be colder than the upper end. By means of the principle of the heat pipe the heat of the hotter lower end is conducted to the cooler upper end and dissipated there. As a result of this heat transfer from the lower to the upper end, the screw is altogether cooled. Consequently the screw can be used in thermally loaded environments. The screw can be used accordingly at higher temperatures since the heat which is transferred onto the screw at the lower end can be quickly dissipated at the upper end.

In an advantageous development, the cavity is constructed as a bore. The principle of the heat pipe is valid in cavities which are not formed as a pipe, i.e. not with a circular cross section. If the cross section of the heat pipe is triangular, quadrangular, or assumes a similar geometric shape, these heat pipes which are formed in such a way demonstrate the same physical effect as heat pipes with a circular cross section. A bore, however, is comparatively simple to construct compared with a triangular, quadrangular or similar cross section. As a result, the advantage is achieved of the screw with a cavity which is constructed as a bore being able to be inexpensively constructed. The screws which are used according to the prior art frequently already have a defmed bore if they are used as expansion screws.

In a further advantageous development, a part of the wall of the cavity projects out beyond the upper end. With the extension of the heat pipe above the upper end of the screw, the effect is achieved of the heat which is absorbed by the lower hot end being able to be conducted into a region of the heat pipe which can be particularly simply cooled. This cooling does not have to be actively carried out, the cooling can be carried out alone as a result of the geometric distance to the hot components on account of the temperature difference to the environment. If a part of the wall of the cavity projects out so to speak beyond the upper end, then this part experiences another lower temperature than the rest of the heat pipe, as a result of which a better cooling action can be achieved.

In a further advantageous development, the wall which projects out beyond the upper end is at least as long as the part of the wall which is in the screw.

It has been shown that this geometric configuration, in which the part which projects out of the screw is at least as long as the part which is in the screw, demonstrates a particularly effective cooling action.

The object is also achieved by means of a screw with a lower and an upper end for connecting a first component to a second component, wherein the screw comprises a bore, wherein a heat pipe is arranged in the bore, wherein the heat pipe is formed for filling with a medium.

The principle of the heat pipe is also utilized here. According to the invention, a screw is introduced in which the heat pipe can be arranged in a bore of the screw. The cooling action is carried out according to the same physical principle as described above. The screw which is formed with a heat pipe in the bore, however, is comparatively simpler to produce. As a result, costs are reduced. The screw comprises at least two component parts in this embodiment. For one thing, this would be a screw which is provided with a bore, and a heat pipe which is inserted in the bore. The heat pipe in this case can consist of the same material as the screw, but different materials can also be used for the heat pipe and for the screw.

In a further advantageous development, liquid sodium or liquid potassium is used as medium. Temperatures of over 500° C. are reached especially in steam turbine construction. Liquid sodium or liquid potassium, therefore, is a suitable candidate for this temperature range.

### BRIEF DESCRIPTION OF THE DRAWINGS

Exemplary embodiments of the invention are subsequently described in more detail with reference to the drawings. In this case, components which are provided with the same designations have the same principle of operation.

In this case, in the drawing:

FIG. 1 shows a perspective view of a steam valve for a steam turbine,

FIG. 2 shows a plan view of the steam valve according to FIG. 1,

FIG. 3 shows a sectional view of a screwed connection,

FIG. 4 shows a sectional view of a screwed connection in an alternative embodiment,

FIG. 5 shows a sectional view of a screwed connection in an alternative embodiment.

### DETAILED DESCRIPTION OF THE NVENTION

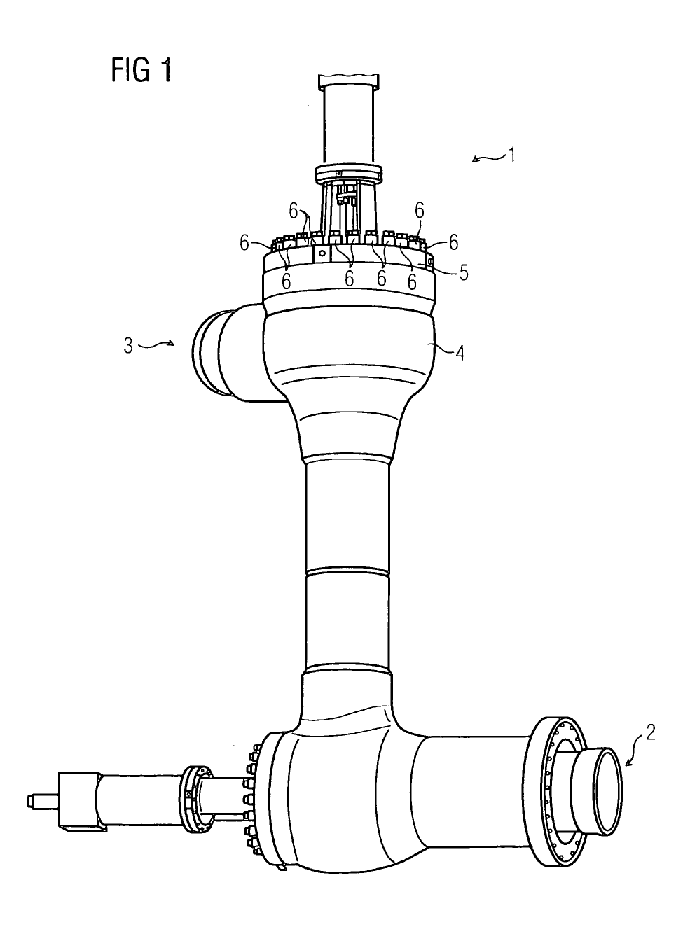

In FIG. 1, a steam valve 1 is shown in perspective view. An essential feature of the steam valve I is the inflow section 3 where steam flows in with very high temperatures. This steam is guided to the outflow section 2 through passages which are not shown in FIG. 1. The steam valve 1 is constructed essentially with a cylindrical shape and comprises a first component 4 and a second component 5. The second component 5 is constructed as a cover. The first component 4 is constructed with a cylindrical shape. The first component 4 is connected to the second component 5 by means of screws 6. Since especially in steam turbine construction the steam valves 1 are exposed to admission of steam which has very high pressures, a plurality of screws 6 are provided for connecting the first component to the second component 5 in order to withstand the high forces.

The invention is not limited to the connection of a first component 4 and a second component 5 of a steam valve. The first component 4 or the second component 5 could also be the upper section and the lower section of an inner casing of a steam turbine. The first component 4 and the second component 5 could also be formed as an outer casing of a steam turbine.

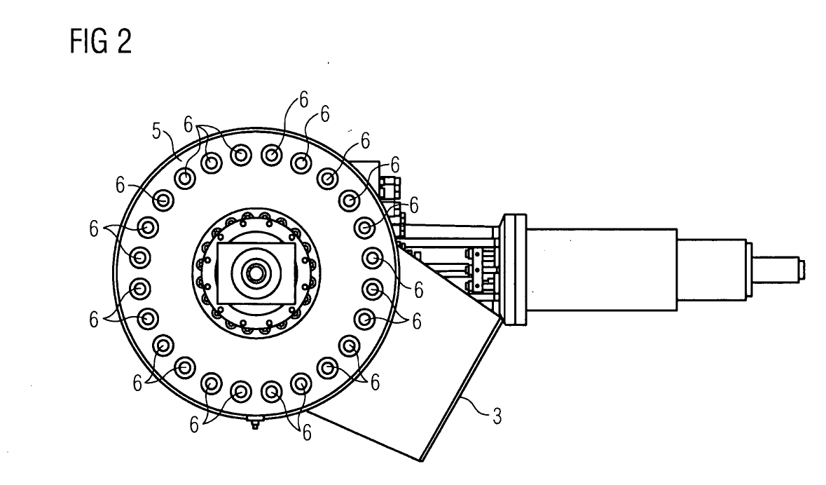

In FIG. 2, a plan view of the steam valve according to FIG. 1 is to be seen. The cover 5, as an embodiment of the second component, is constructed with a circular shape and comprises a plurality of holes into which the screws 6 are inserted. Threads are arranged in the first component 4, which are formed in alignment with the holes.

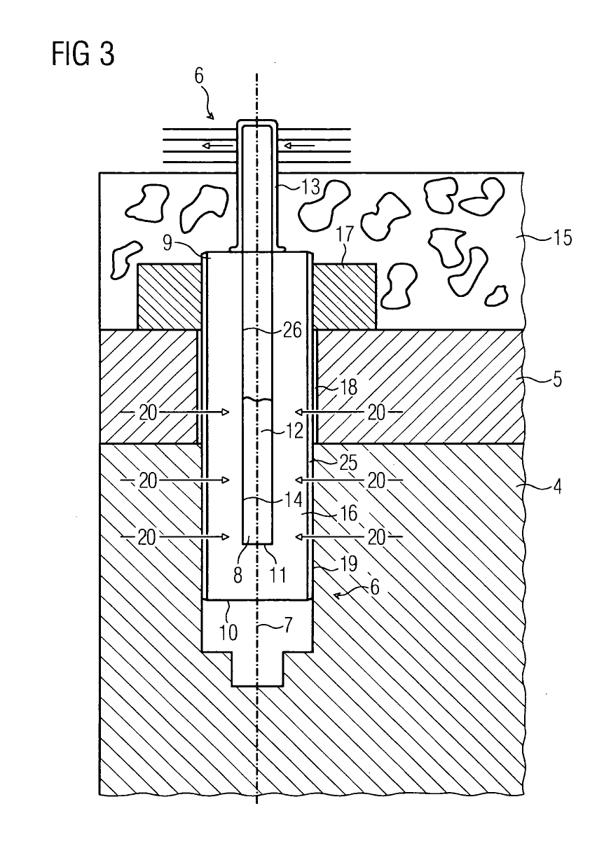

In FIG. 3, a sectional view through a screw 6 is to be seen. The screw 6 connects the first component 4 to the second component 5. The screw 6 is provided in its longitudinal direction 7 with a cavity 8. The screw 6 has an upper end 9 and a lower end 10. The cavity 8 has a bottom 11 at the lower end 10 for forming a beaker-like cavity 8. The beaker-like cavity 8 is formed for filling with a medium 12. At the upper end 9 of the screw, a part of the wall 13 of the cavity 8 projects out beyond the upper end. The wall 13 can be formed as a sleeve which is designed so that the space above the upper end 9 of the screw is constructed in a closed manner. The cavity 8 can be constructed as a bore. Other embodiments, such as a triangular or a quadrangular cross section, are possible.

The wall 13 of the cavity 8 can be equipped with capillaries 26 along the length, which leads to the cooling medium being delivered to the bottom 11 even in the case of a non-vertical installed position.

The wall 13 which projects out beyond the upper end 9 can be exactly as long as the part of the wall 14 which is in the screw 6, but can also be longer or shorter.

The cavity 8 is constructed in a closed manner.

The screw 6 can be formed as a threaded rod 16 and with a nut 17 located at the upper end 9. The second component 5 comprises a hole 18. A further hole 19 with a thread which aligns with the hole 18 in the second component is arranged in the first component 4. The threaded rod 16 is first of all screwed into the hole 19 with the thread 25. The nut 17 is then attached on the upper end 9 of the threaded rod 16 and screwed down with high torque. With this, a preheating of the screw is also possible in order to create a defined tightening force.

The medium 12 which is in the cavity 8 for example can be liquid sodium or liquid potassium. During operation, heat flows along a heat flux 20. The lower part 10 of the screw is heated in this case, which leads to the medium 12 being able to be hot in such a way that it evaporates and precipitates again and condenses on the wall 13 at the upper end. In doing so, heat is given off, which is carried away by the environment or by another external cooling medium.

An insulation 15 for thermal insulation of the component can additionally be arranged around the screw 6. In this case, the pipe must be at least long enough for the wall 13 with the end of the pipe which is to be cooled to lie outside the insulation.

Materials of low-order material grades can be used for the screw on account of the cooling. In the high-temperature range, for example highly chromiferous steels can be used instead off nickel-based alloys (for example X19CrMoNbVN11-1 instead of nimonic). At lower temperatures, more cost-effective and more easily available 1%-chromium steels can be used instead of highly chromiferous steels (for example, 21CrMoV5-7 instead of X19CrMoNbVN11-1).

With regard to the dimensions, it is advantageous if the length of the screw features 150 to 800 mm, and a thread according to DIN features between M56 and M180.

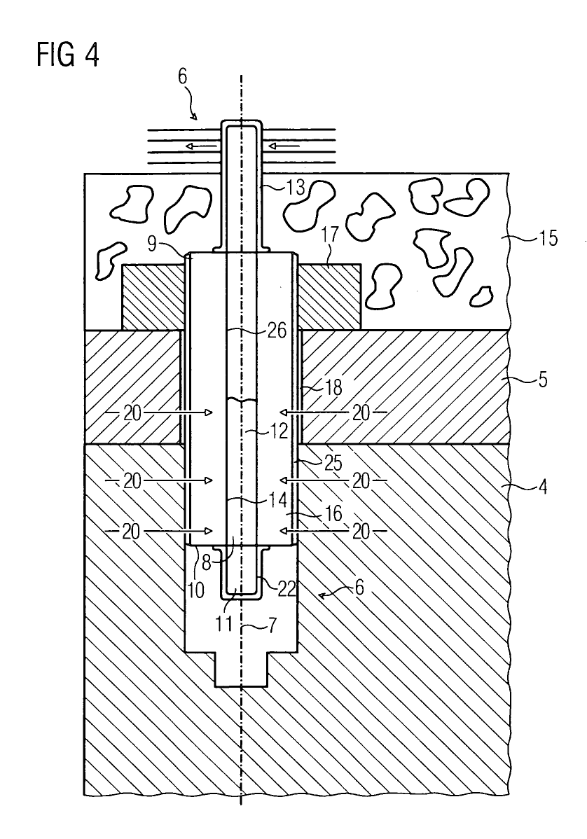

In FIG. 4, an alternative embodiment of the screw 6 is shown. The difference of the screw 6 which is shown in FIG. 4 to the screw 6 which is shown in FIG. 3 is that of the bottom 11 at the lower end 10 of the screw being formed by means of a beaker-like sleeve 22. The cavity 8 is consequently constructed as a continuous bore from the upper end 9 to the lower end 10 of the screw 6. The sleeve 22 with the beaker-like bottom 11 is welded, riveted or soldered on the lower end 10 of the screw. Other connecting possibilities are conceivable. The principle of operation and the remaining component parts of the screw are identical to those in FIG. 3. Therefore, the explanations for FIG. 3 are referred to here.

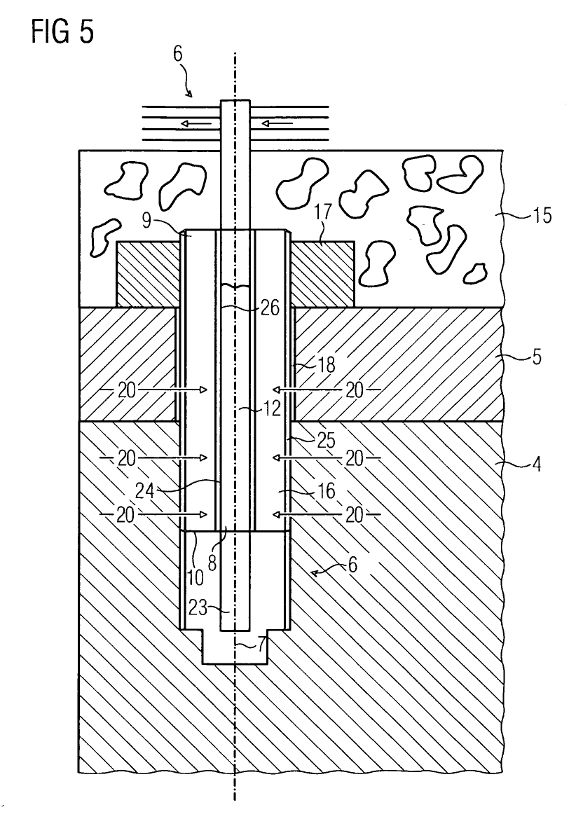

In FIG. 5, a further alternative embodiment of the screw 6 is shown. The screw 6 is formed in such a way that a closed heat pipe 23 is arranged in a bore 24 which has a slightly larger diameter than the diameter of the heat pipe 23. The heat pipe 23 is longer than the threaded rod 16 and projects out beyond the upper end 9 and the lower end 10. The heat pipe 23 does not unconditionally have to project out at the lower end 10. The heat pipe can terminate at the lower end 10 flush with the threaded rod 16. The bore does not have to be continuous, but can go as far as the lower end 10. The principle of operation of the screw 6 is otherwise almost identical to the principle of operation of the screw 6 as described in FIGS. 3 and 4. Therefore, the explanations for FIGS. 3 and 4 are referred to here.

1.-14. (canceled)

15. A screw for connecting a first component to a second component, comprising:
an upper end;
a lower end; and
a cavity arranged in a longitudinal direction of the screw that fills with a medium for cooling the screw,
wherein the cavity is configured to have a bottom at the lower end of the screw for forming a beaker-like cavity.

16. The screw as claimed in claim 15, wherein the cavity comprises a bore.

17. The screw as claimed in claim 15, wherein a part of a wall of the cavity projects out beyond the upper end.

18. The screw as claimed in claim 17, wherein the part of the wall that projects out beyond the upper end is at least as long as a part of the wall that is in the screw.

19. The screw as claimed in claim 15, wherein the cavity is a closed cavity.

20. The screw as claimed in claim 15, wherein the medium comprises liquid sodium or liquid potassium.

21. The screw as claimed in claim 15, wherein the screw is used in a turbomachine.

22. A screw for connecting a first component to a second component, comprising:
an upper end;
a lower end;
a bore; and
a heat pipe arranged in the bore that fills with a medium for cooling the screw.

23. The screw as claimed in claim 22, wherein the bore comprises capillaries.

24. The screw as claimed in claim 22, wherein the bore is continuous from the upper end to the lower end.

25. The screw as claimed in claim 22, wherein the heat pipe projects out beyond the lower end.

26. The screw as claimed in claim 22, wherein the heat pipe projects out beyond the upper end.

27. The screw as claimed in claim 22, further comprising a threaded rod and a nut.

28. The screw as claimed in claim 22, wherein the medium comprises liquid sodium or liquid potassium.

29. The screw as claimed in claim 22, wherein the screw is manufactured from a material selected from the group consisting of: X19 CrMoVN11-1, 21CrMoV5-7, and nimonic.

30. The screw as claimed in claim 22, wherein a length of the screw is between 150 mm to 800 mm.

31. The screw as claimed in claim 22, wherein a thread of the screw is between M56 and M180 according to DIN.

32. The screw as claimed in claim 22, wherein the screw is used in a turbomachine.
